(19) United States
(12) Patent Application Publication
(10) Pub. No.: US 2026/0296851 A1
(43) Pub. Date: Oct. 1, 2026

(54) LEVELING RAMP

(71) Applicant: CAMCO MANUFACTURING, LLC, Greensboro, NC (US)

(72) Inventors: Brandon Blakely, Burlington, NC (US); Claire Hayes Clark, Stuart, VA (US); Niko Jovicevic, Statesville, NC (US)

(21) Appl. No.: 19/096,356

(22) Filed: Mar. 31, 2025

(51) Int. Cl. B66F 7/24

(52) U.S. Cl. CPC B66F 7/243

(57) ABSTRACT

A leveling ramp and leveling ramp system may include a frame comprising a bottom surface, a top surface, a rear end, a front end, and side surfaces, the top surface being curved to accommodate a tire, the front end being angled to facilitate driving onto the leveling ramp, the bottom surface including a plurality of locking features, wherein the locking features comprise cutouts integrated into the frame, the bottom surface including a notch, the notch integrated into at least one of the locking features, a bump stop disposed on the top surface adjacent to and extending from the rear end, where the bump stop and the notch define a complementary transport pattern, and a through-hole disposed through the center of the top surface. The leveling ramp kit further including a lock and carry system compatible with a plurality of leveling ramps.

### TECHNICAL FIELD

The present disclosure relates generally to vehicle stabilization. In particular, some aspects of the disclosure may relate to systems for storing, transporting, and using recreational vehicle (RV) leveling ramps.

### DESCRIPTION OF RELATED ART

Leveling larger vehicles such as RVs, campers, and trailers is important both for the comfort of occupants and the proper functioning of onboard appliances and furnishings. A variety of systems, devices, and methods exist attempting to achieve this, yet many present challenges or limitations.

Traditional approaches often involve using containers, boxes, cases, and/or bags to store and transport leveling blocks. These containers, typically constructed from materials such as fabric, canvas, or plastic, often include handles or straps for carrying. However, they add significant weight and cost to the system and tend to be bulky, requiring additional storage space, as well as retail shelf space. Further, the containers are often not made from transparent materials, making the design and aesthetics of the leveling blocks obscured from potential buyers.

Typical RV leveling ramps involve two operations. They often require driving the RV onto a first curved block until the vehicle is level, then either getting out of the vehicle or having a second person wedge a second piece of material, often plastic, into the exposed area to keep the vehicle in place. Leveling blocks are also commonly used. Such blocks may interlock to form ramps as needed but are prone to breaking apart and are not as effective on rougher terrain.

Setting up these typical leveling ramps can be time consuming and a real test of patience. If the driver of the vehicle drives too far onto the ramp and its uneven, the driver must redo every tire until the vehicle is level. Even with a second person, putting these manual ramps in place can take multiple attempts and repeated trial and error. An RV, which is not level, can lead to numerous issues as many RV systems, such as refrigerators and restrooms, require being approximately level to function properly.

As discussed, storing typical leveling ramps often involves an extra bag. This bag provides yet another item to keep track of when storing the leveling ramps. The odd shapes of the ramps can lead to errors fitting the ramps back into the bag. Further, if the stored ramps are tossed about, the leveling ramps could be damaged or worse, lost.

### BRIEF SUMMARY OF THE DISCLOSURE

Embodiments of the present disclosure address issues present in traditional systems by introducing a leveling ramp that includes a frame. The frame of the leveling ramp may include a bottom surface, a top surface, a rear end, a front end, and side surfaces, the top surface being curved to accommodate a tire, the front end being angled to facilitate driving onto the leveling ramp, the bottom surface includes a plurality of locking features, where the locking features comprise cutouts integrated into the frame, the bottom surface includes a notch, the notch integrated into at least one of the locking features, a bump stop disposed on the top surface adjacent to and extending from the rear end, where the bump stop and the notch define a complementary transport pattern, and a through-hole disposed through the center of the top surface.

The leveling ramp may also include a mound disposed between the top surface and the front end that extends away from the top surface and a complementary valley on the bottom surface such that, when a second leveling ramp is stacked on a first leveling ramp, the mound rests in a complementary valley.

The leveling ramp may also further include a lock and carry system, the lock and carry system may include a grip and a shaft, the grip positioned at a first end and the shaft releasably attached to the grip and terminating at a second end, the first end and the second end in opposing relation to one another, the second end defining a first engagement member, and a receiver includes a base, a shank, the shank extending from the base and terminating at a lip, and a second engagement member, where the shank defines a passageway that is configured to receive at least a portion of the first engagement member, and where the first engagement member secured to the second engagement member.

The leveling ramp may also include where at least one of the plurality of locking features is square-shaped. The leveling ramp may also include wherein the bump stop is configured to provide tactile feedback to a driver when a vehicle is positioned correctly on the leveling ramp.

In further embodiments, the present disclosure may provide for a recreational vehicle ramp for stabilizing or lifting a recreational vehicle off a ground surface. The recreation vehicle ramp may include a molded-plastic frame with a bottom surface with depressed locking features, a curved top surface, a rear end, and angled front end, and two side surfaces, the curved top surface being concave to accommodate a recreational vehicle tire, the angled front end being rectilinear to the bottom surface and configured to facilitate driving onto the recreational vehicle ramp, the bottom surface may include two or more depressed locking features and a notch, where the locking features comprise square-shaped cutouts integrated into the molded-plastic frame and where the notch is further integrated into the square shaped cutouts, a handle integrated into both side surfaces of the molded-plastic frame, and a leveling block, which may include square locking protrusions disposed on a leveling block platform.

The recreational vehicle ramp may also include where the square locking protrusions of the leveling block correspond to the depressed locking features of the bottom surface, such that when the frame is disposed on the leveling block, the frame is secured to the leveling block by the square locking protrusions securing within the depressed locking features.

The recreational vehicle ramp may also further include a lock and carry system, the lock and carry system may include a grip and a shaft, the grip positioned at a first end and the shaft releasably attached to the grip and terminating at a second end, the first end and the second end in opposing relation to one another, the second end defining a first engagement member, and a receiver that may include a base, a shank, the shank extending from the base and terminating at a lip, and a second engagement member, where the shank may define a passageway that is configured to receive at least a portion of the first engagement member, and where the first engagement member secured to the second engagement member.

The recreational vehicle ramp may also include where the two or more depressed locking features includes six depressed locking features. The recreational vehicle ramp may also include a bump stop configured to provide tactile feedback to a driver when the recreational vehicle is positioned correctly on the recreational vehicle ramp. The recreational vehicle ramp may also include where the angled front end further includes a first angled end affixed to the bottom surface and a second angled end affixed to the curved top surface, where the interim surface between the first and second angled ends is substantially flat.

In further embodiments, the present disclosure may include a leveling ramp. The leveling ramp may include a first leveling ramp, a second leveling ramp, and a lock and carry system, each of the first and second leveling ramps may include a bottom surface, a top surface, a rear end, a front end, and side surfaces, each top surface being curved to accommodate a tire, each front end being angled to facilitate driving onto the leveling ramp, each bottom surface may include a plurality of locking features, where the locking features comprise square-shaped cutouts integrated into the bottom surface, a bump stop disposed at a junction of the rear end and top surface, extending away from the top surface in line with the rear end, a handle integrated into at least one of the side surfaces of each leveling ramp, and a through-hole disposed in the center of each top surface, where the first leveling ramp is configured to be stacked on the second leveling ramp and secured together via the lock and carry system.

The leveling ramp may also include where the lock and carry system further includes a grip and a shaft, the grip positioned at a first end and the shaft releasably attached to the grip and terminating at a second end, the first end and the second end in opposing relation to one another, the second end defining a first engagement member, and a receiver includes a base, a shank, the shank extending from the base and terminating at a lip, and a second engagement member, where the shank defines a passageway that is configured to receive at least a portion of the first engagement member, and where the first engagement member secured to the second engagement member.

The leveling ramp may also include a leveling block with square locking protrusions disposed on a leveling block platform. The leveling ramp may also include where each leveling ramp includes six locking features. The leveling ramp may also include where the first leveling ramp is stacked on top of the second leveling ramp and the bump stop of the second leveling ramp secured within a notch of the first leveling ramp. The leveling ramp may also include a third leveling ramp stackable with the first and second leveling ramps and securable with the lock and carry system. The leveling ramp may also include where the through-hole is configured to receive the lock and carry system. The recreational vehicle ramp may also include further includes a through-hole disposed in the center of the curved top surface configured to secure the lock and carry system therein. The leveling ramp may also include where the notch is integrated into at least two of the locking features integrated into the bottom surface of each leveling ramp.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto and their equivalents thereof.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a diagram showing a perspective illustration of an example expanded leveling ramp, in accordance with various embodiments of the disclosed technology.

FIG. 2 is a diagram showing a perspective illustration of an example leveling ramp, in accordance with various embodiments of the disclosed technology.

FIG. 3 is a diagram showing a raised perspective illustration of an example leveling ramp, in accordance with various embodiments of the disclosed technology.

FIG. 4 is a diagram showing a lowered perspective illustration of an example leveling ramp, in accordance with various embodiments of the disclosed technology.

FIG. 5 is a diagram showing a side plan illustration of an example tire disposed on a leveling ramp further disposed on a leveling block, in accordance with various embodiments of the disclosed technology.

FIG. 6 is a diagram showing a perspective illustration of an example UL ramp disposed on a leveling block, in accordance with various embodiments of the disclosed technology.

FIG. 7 is a diagram showing a perspective illustration of an example leveling block, in accordance with various embodiments of the disclosure technology.

The figures are not exhaustive and do not limit the present disclosure to the precise form disclosed.

### DETAILED DESCRIPTION

The present disclosure addresses various challenges associated with leveling a recreational vehicle (RV). Traditional approaches often involve cumbersome and time-consuming methods to level RVs. These methods lack efficiency and durability. The disclosed leveling ramp system innovatively addresses these problems by providing a sturdy and effective way to level an RV, as well as an efficient way to carry the leveling ramps used therein.

Embodiments of the leveling ramp system introduced in this disclosure represents an improved solution to challenges faced in the RV industry. The leveling ramp system allows for easier storage and transport of the leveling ramps themselves and provides for an improved user experience when leveling an RV with embodiments described herein.

Embodiments of the leveling ramp system may include one or more leveling ramps. The leveling ramps may include a frame, comprising a bottom surface, a top surface, a rear end, a front end, and one or more side surfaces. As discussed herein, the top surface may be concave or curved to fit a portion of the circumference of a tire, when an RV tire is parked on the leveling ramp. The bottom surface may include locking features to combine the leveling ramp with a leveling block to further adjust the height of the ramp and subsequently the RV parked thereon. The side surfaces may be textured and include a handle to allow a user to pull the leveling ramp from beneath an RV without having to dig one's fingers into the ground to grasp around the frame of the leveling ramp. The front end may be angled with a first angled end affixed to the bottom surface and a second angled end affixed to the top surface. The interim area of the front end may be substantially flat to allow a tire to approach the leveling ramp, interact first with the first angled end, proceed up the interim area, traverse the second angled end and mound, and position on the top surface for short-or long-term parking. The rear end may be flat or textured and may extend beyond the top surface to form a bump stop, which may provide tactile feedback to a user, once the tire has driven onto the top surface, regarding the maximum lateral traversal distance the tire can rotate before falling off the rear of the leveling ramp.

Embodiments of the leveling ramp system may further include a lock and carry system. The lock and carry system may include a grip and a shaft, the grip may be positioned at a first end of the shaft and be releasably attached to the shaft, terminating at a second end. The first end and second end may be in opposing relation to one another. The second end may define a first engagement member, which may be configured to releasably secure to a complementary second engagement member integrated into a receiver. The receiver may include a base, a shank, the shank extending from the base and terminating at a lip, and the second engagement member, where the shank may define a passageway that is configured to receive at least a portion of the first engagement member, and where the first engagement member may be secured to the second engagement member. Other technical features may be readily apparent to one skilled in the art from the following figures, descriptions, and claims.

The various component features of the leveling ramp may be constructed from plastic, metal (e.g., aluminum, titanium, steel, etc.), polymer, carbon fiber, composite materials, structural foam, resin, wood, or similar durable materials. In other embodiments, some or all component features may be constructed from flexible materials such as rubber, silicone, or similar property materials to allow for increased traction and variability between the leveling ramp and the tire. Each leveling ramp may be a single, solid piece of material and include varying thicknesses of the material throughout the structure. Alternatively, each leveling ramp may be constructed from multiple pieces constructed from the same or different materials. The versatility in material selection may allow for leveling ramp customization for specific needs, preferences of users, varying terrains, and/or diverse weather conditions.

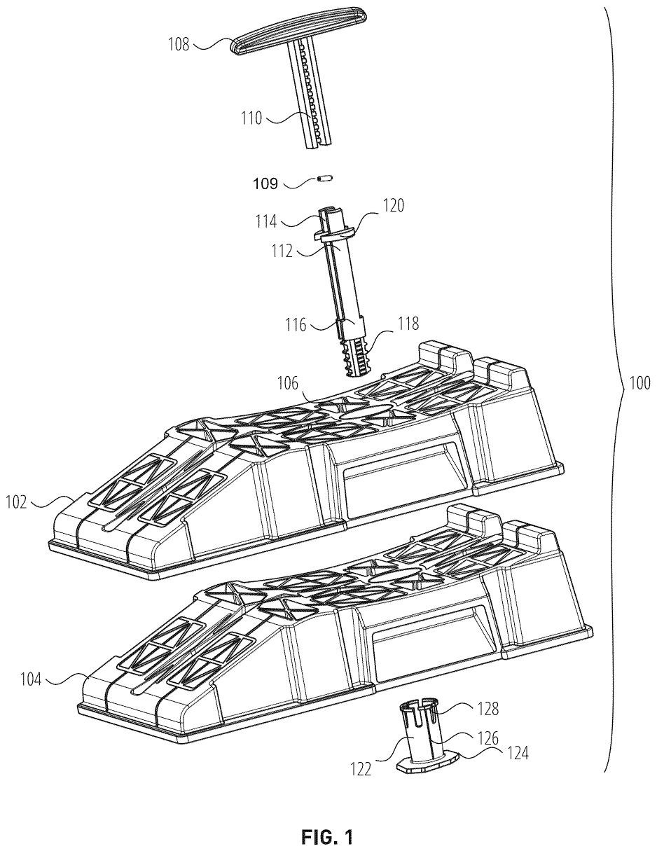

Referring now to the figures, FIG. 1 is a diagram showing a perspective illustration of an example expanded leveling ramp, in accordance with various embodiments of the disclosed technology. The leveling ramp 100 may include a first leveling ramp 102, a second leveling ramp 104, a through-hole 106, a grip 108, a top shaft 110, a shaft 112, a first end 114, a second end 116, a first engagement member 118, a collar 120, a receiver 122, a base 124, a shank 126, and a lip 128.

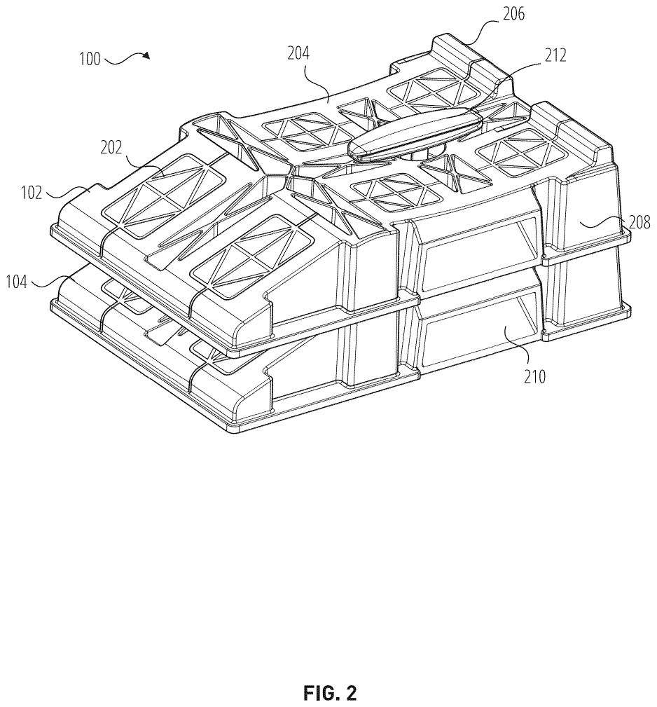

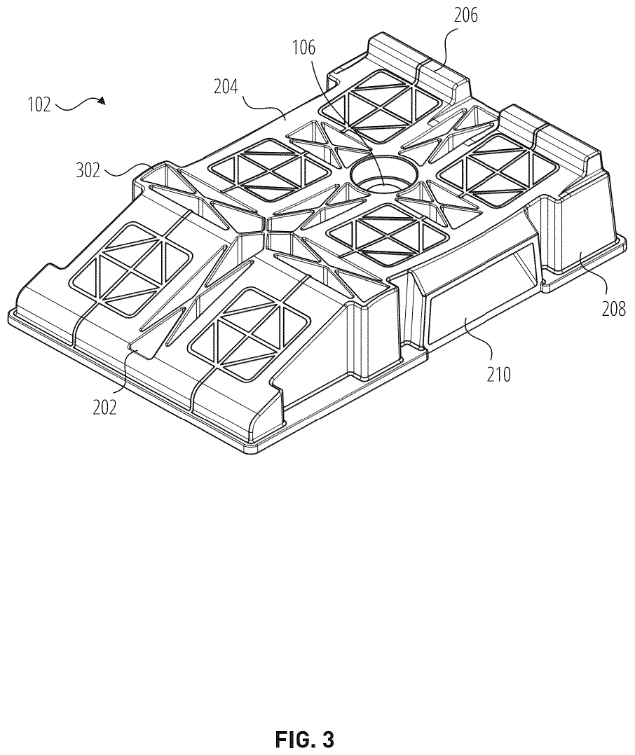

Embodiments of the leveling ramp 100 system may include various components. For example, as depicted, the leveling ramp 100 may include a first leveling ramp 102, a second leveling ramp 104, and a lock and carry system (as depicted by 108-128). The lock and carry system may secure through the first and second leveling ramp 102, 104 via through-holes 106 placed through a center area of each leveling ramp. The configuration of the leveling ramps 102, 104 and through-holes 106 is discussed in relation to FIGS. 2-3.

In other embodiments, the leveling ramp 100 system may include more than two leveling ramps or may include less than two leveling ramps. Further embodiments may also include other components secured by the lock and carry system, for example, a leveling block with a leveling block through-hole may be secured below the second leveling ramp 104. In further embodiments, the lock and carry system may exclusively carry leveling blocks or may carry a wider variety of RV stabilization tools.

In particular to FIG. 1, the leveling ramp 100 may include a lock and carry system. The lock and carry system may include three releasably attached components. The components may include a grip 108 affixed to a top shaft 110, a pin 109, a shaft 112, and a receiver 122. The grip 108 may be perpendicularly affixed to the top shaft 110 or may be affixed to the top shaft 110 at an angle. The grip 108 may be tubular, oblong, or ergonomically structured to form to a user's hand. The grip 108 may be held by a user during both transport of the leveling ramp 100 or during opening and/or securing of the lock and carry system. The grip 108 may further include an integrated light to illuminate a work area when a user is installing or removing the leveling ramp system.

The top shaft 110 may be structurally affixed to the grip 108. For example, the grip 108 and top shaft 110 may be formed as a single piece during plastic molding. In other embodiments, the grip 108 and top shaft 110 may two separate components that are releasably or non-releasably affixed to each other. The top shaft 110 and grip 108 may be releasably secured to a first end 114 of the shaft 112 and may be detachable from the shaft 112 by any repeatedly detachable mechanism. For example, a pin 109 may secure the first end 114 to the top shaft 110. The shaft 112 may terminate at a second end 116, wherein the second end 116 may include a first engagement member 118. The first engagement member 118 may be a screw or other releasable engaging feature. The first end 114 of the shaft 112 may further include a collar 120 that encircles a portion of, or the entirety of, the circumference of the shaft 112. The collar 120 may rest in a top area of the through-hole 106 of the first leveling ramp 102 and prevent the first leveling ramp 102 from impacting the fingers of a user when carrying the leveling ramp 100 and may further secure the leveling ramps from moving horizontally during transport.

The second end 116 comprising the first engagement member 118 may secure through the through-holes 106 of the leveling ramps to a receiver 122 comprising a second engagement member (depicted with reference number 92 in U.S. patent application Ser. No. 18/446,991, incorporated herein). The receiver 122 may include a base 124, a shank 126, the shank 126 perpendicularly extending from the base 124 and terminating at a lip 128. The shank 126 may be tubular and define a passageway that may be configured to receive at least a portion of the first engagement member 118. In other words, a portion of the first engagement member 118 may be secured to the second engagement member disposed within the shank 126. The first engagement member 118 and the second engagement member may be complementary.

FIG. 2 is a diagram showing a perspective illustration of an example leveling ramp with two leveling ramps and a lock and carry system, in accordance with various embodiments of the disclosed technology. The leveling ramp 100 may include a first leveling ramp 102, a second leveling ramp 104, an angled front end 202, a curved top surface 204, a side surface 208, a handle 210, a bump stop 206, and a lock and carry system 212.

The first leveling ramp 102 and the second leveling ramp 104 may be substantially similar including comparable features, dimensions, and construction. For purposes of discussion, reference will be made to the component features of the first leveling ramp 102, but one skilled in the art would understand the applicability of the features of the first leveling ramp 102 to the second leveling ramp 104. Furthermore, more than two leveling ramps may be practiced. In such embodiments, the third through nth leveling ramps may include substantially similar features.

In particular to FIG. 2, the first leveling ramp 102 may include an angled front end 202. The angled front end 202 may include a first angled end affixed to the bottom surface and a second angled end affixed to the mound and curved top surface 204. The interim area between the first angled end and the second angled end may be substantially flat or curved to accommodate a tire being driven thereon. The angle of the interim area may be approximately 10 degrees to 55 degrees in relation to the bottom surface or ground surface, whichever is closer to horizontal. The angled front end 202 may be at a fixed angle, permitting an RV to approach the leveling ramp 102, engage a tire with the first angled end, proceed up the interim area, traverse the mound and arrive at the curved top surface 204. The angled front end 202 may include various cutouts of different geometries. The cutouts may provide additional traction for the tire while traversing the interim area and/or may provide for reduced weight of the overall leveling ramp 102. Other materials may be disposed on top of the angled front end 202, for example rubber or “sticky” spray to increase the friction coefficient between the angled front end 202 and the tire, thereby reducing slippage.

The first leveling ramp 102 may further include a curved top surface 204. The curved top surface 204 may be separated from the angled front end 202 by a mound (discussed in relation to FIG. 3). The curved top surface 204 may include a top length and a top width. The top length may be uniform or varied across the curved top surface 204. Similarly, the top width may be uniform of varied across the curved top surface 204. The top length may be from 1 inch to 48 inches and the top width may be from 1 inch to 36 inches. The curved top surface 204 may be concave, such that a center region (e.g., the area surrounding the through-hole 106) of the curved top surface 204 may be at a lower plane of elevation than either end (e.g., the area adjacent to the mound or bump stop) of the curved top surface 204. The curved top surface 204 may include cutouts to similarly improve traction and/or reduce the overall weight of the leveling ramp. Further, the curved top surface 204 may include a through-hole 106. The through-hole 106 may be bored there-through, e.g., from the curved top surface 204 to bottom surface of the leveling ramp. The through-hole 106 may include a top shelf that the collar 120 of FIG. 1 may rest on to secure the leveling ramp from raising during transport. Other materials may be disposed on top of the curved top surface 204, for example rubber or “sticky” spray to increase the friction coefficient between the curved top surface 204 and the tire, thereby reducing slippage.

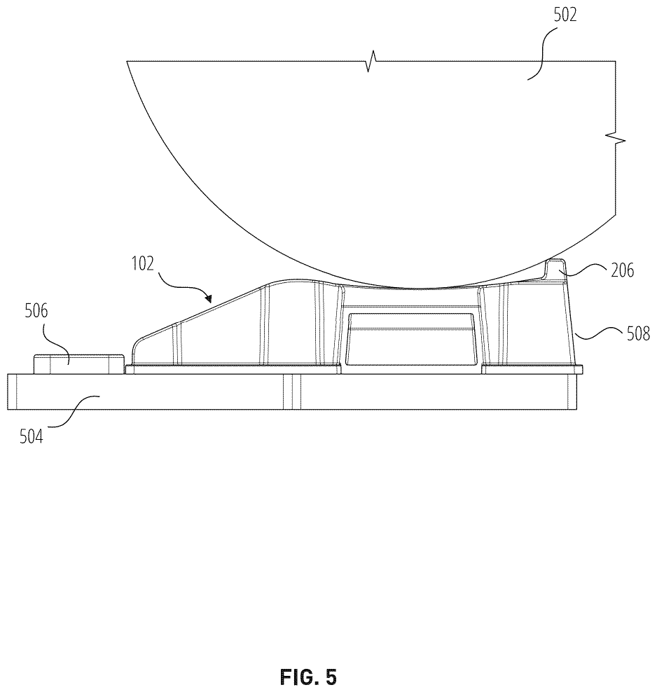

The first leveling ramp 102 may include a bump stop 206 disposed on the lengthwise opposing end of the curved top surface 204 from the mound and the angled front end 202. The bump stop 206 may extend approximately perpendicularly from the curved top surface, in plane with the rear end (as discussed in relation to FIG. 5). The bump stop 206 may provide tactile feedback to the driver of the RV by providing for an area for the tire to “bump” against once the tire is correctly placed onto the curved top surface 204. Correct placement of the tire can by dynamic based on the conditions the leveling ramp is placed in, however, generally correct placement of the tire can refer to positioning of the tire in the approximate rotational center of the curved top surface 204. Rotational center meaning further rotation would move the tire forward towards the bump stop and a reduction in rotation would move the tire back towards the mound and angled front end 202. Correct placement does not account for lateral positioning of the tired, e.g., the tire hanging off of the side of the curved top surface 204.

The first leveling ramp 102 may further include a side surface 208. The side surface 208 may be adjacent to both the angled front end 202 and the curved top surface 204. Each leveling ramp may include two side surfaces 208, however, other embodiments may exist that include more or less side surfaces. Each side surface may be flat or textured. The texture of each side surface 208 may include indents or cutouts to reduce the overall weight of the leveling ramp. Embedded in the side surface 208 may be a handle 210. The handle may be a cut into the frame of the leveling ramp such that one's fingers would lay inside the frame of the leveling ramp, compared to the position of the side surface 208, when grabbing the leveling ramp via the handle 210. The handle 210 may be cut up or down into the ramp such that a user's finger may curl palm down or palm up, respectively, to secure around the handle 210. The handle 210 may be used by an RV user to remove or place the leveling ramp beneath an RV so that the user's fingers do not have to touch the ground surface or curved top surface 204 of the leveling ramp. By integrating the handle 210 into the leveling ramp, the user is no longer subjected to the risk of dirtying their fingers when placing or removing the leveling ramp or crushing their fingers if the RV were to drive onto the ramp while the user is grabbing the handle 210.

The first leveling ramp 102 may also include a lock and carry system 212. The lock and carry system 212 is described in relation to FIG. 1 with reference to numbers 108-128. Due to the curved nature of the top surface and the placement of the collar and top shelf, a user's finger may be able to wrap around the grip of the lock and carry system 212 without contacting or being crushed by the curved top surface 204.

FIG. 3 is a diagram showing a raised perspective illustration of an example leveling ramp, in accordance with various embodiments of the disclosed technology. The leveling ramp depicted in FIG. 3 may include similar features to the first leveling ramp 102 depicted in FIGS. 1 & 2. For example, the leveling ramp 102 of FIG. 3 may include a through-hole 106, an angled front end 202, a curved top surface 204, a side surface 208, a handle 210, a bump stop 206, and, newly, a mound 302. Discussion regarding the through-hole 106, the angled front end 202, the curved top surface 204, the side surface 208, the handle 210, and the bump stop 206 can be found in relation to FIGS. 1 & 2.

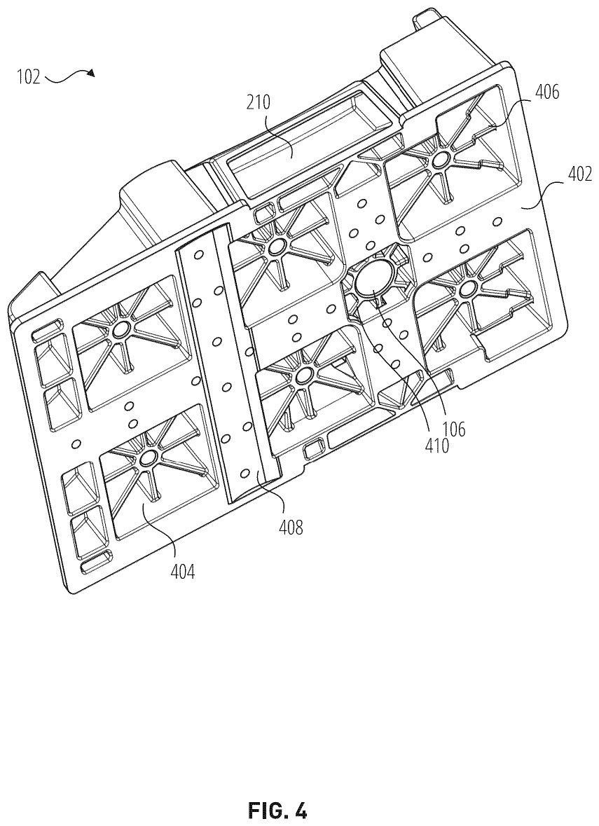

In particular to FIG. 3, the leveling ramp 102 may further include a mound 302. The mound 302 may serve two functions. First, the mound 302 may separate the angled front end from the curved top surface. In such embodiments, the mound 302 may provide tactile feedback to the driver of the RV that the tire has passed the angled front end and arrived at the curved top surface, at which point the driver should prepare to stop the RV once they feel the bump stop. Second, the mound 302 may interlock with the complementary valley (discussed in relation to FIG. 4). By interlocking with the complementary valley, the mound 302 may prevent the first leveling ramp from spinning in relation to the second leveling ramp when the two leveling ramps are secured by a lock and carry system. The mound 302 may extend perpendicularly away from an end of the curved top surface and may be rounded. The mound 302 may include a solid surface or may include texture or cutouts to increase traction and reduce weight. The mound 302 may extend across the entire or partial width of the curved top surface or may extend beyond the edges of the width of the curved top surface.

FIG. 4 is a diagram showing a lowered perspective illustration of an example leveling ramp, in accordance with various embodiments of the disclosed technology. The leveling ramp 102 may include a through-hole 106, a handle 210, a bottom surface 402, a locking feature 404, a notch 406, a valley 408, and a base shelf 410. The through-hole 106 may be similar to through-hole 106 described in relation to FIG. 1 and the handle 210 may be similar to the handle 210 described in relation to FIG. 2.

In particular to FIG. 4, the leveling ramp 102 may include a bottom surface 402. The bottom surface 402 may be adjacent to the side surfaces and the angled front end. The bottom surface 402 may be in vertically opposing relation to the curved top surface. The bottom surface may include a bottom length and a bottom width. The bottom length may be uniform or varied across the bottom surface 402. Similarly, the bottom width may be uniform of varied across the bottom surface 402. The bottom length may be from 1 inch to 60 inches and the bottom width may be from 1 inch to 36 inches. The bottom surface 402 may be approximately flat or include a slight curvature. Other materials may be disposed on the bottom surface 402, for example rubber or “sticky” spray to increase the friction coefficient between the bottom surface 402 and the ground surface, thereby reducing slippage. The bottom surface 402 may also include spikes, stakes, or protrusions that extend perpendicularly away from the bottom surface 402 and subsequently engage the ground surface to further secure the leveling ramp to the ground surface. This may be advantageous when attempting to park an RV on a reduced traction surface, for example, snow or ice.

The bottom surface 402 may further include locking features 404. The locking features 404 may be integrated into the frame of the leveling ramp. In other words, the locking features 404 may be depressed a distance into the frame of the ramp such than an interior portion of the locking feature 404 is closer to the curved top surface while an edge of the locking feature 404 is disposed in plane, or approximately in plane, with the bottom surface 402. The locking features 404 may include an interior frame to limit the distance the complementary locking protrusions can extend into the frame of the leveling ramp and to improve the structural integrity of the of the leveling ramp despite the presence of the locking features 404. Some embodiments may include six locking features 404, as depicted. However, other embodiments may include more or less locking features 404. For example, embodiments of the leveling ramp designed to complement a 2×2 leveling block may include four locking features.

Embodiments that include at least two locking features 404 at the rear end of the leveling ramp, may further include a notch 406 disposed within each locking feature 404. The notch 406 may be further integrated into the interior frame such that a portion of the interior frame is further cut towards the curved top surface. The notch 406 may complement the bump stop (e.g., bump stop 206 of FIG. 2). In other words, when a first leveling ramp is disposed on a second leveling ramp, the bump stop of the second leveling ramp may rest in the notch of the first leveling ramp, preventing the two leveling ramps from rotating during transport. Furthermore, the notch 406 may provide an area for the bump stop to rest so the leveling ramps are not angled, due to the protruding nature of the bump stop, during transport and storage.

The bottom surface 402 may further include a valley 408. The valley 408 may be a concave depression integrated into the frame of the leveling ramp. The valley 408 serve as a complementary securing area for the mound (e.g., mound 302 of FIG. 3). In other words, the valley 408 may be concavely integrated into the frame of the leveling ramp a complementary amount in relation to the shape and size of the mound. The valley 408 may provide a similar function as the notch 406, e.g., securement of a first and second leveling ramp to prevent rotation during transport and storage.

Further, the bottom surface 402 may include a through-hole 106. The through-hole 106 may be bored there-through, e.g., from the curved top surface to bottom surface 402 of the leveling ramp. The through-hole 106 may include a base shelf 410 that the base (e.g., base 124 of FIG. 1) may rest on to secure the leveling ramp from falling during transport.

FIG. 5 is a diagram showing a side plan illustration of an example tire disposed on a leveling ramp further disposed on a leveling block, in accordance with various embodiments of the disclosed technology. Such embodiments, as depicted, may include a first leveling ramp 102, a bump stop 206, a tire 502, a leveling block 504, a locking protrusion 506, and a rear end 508.

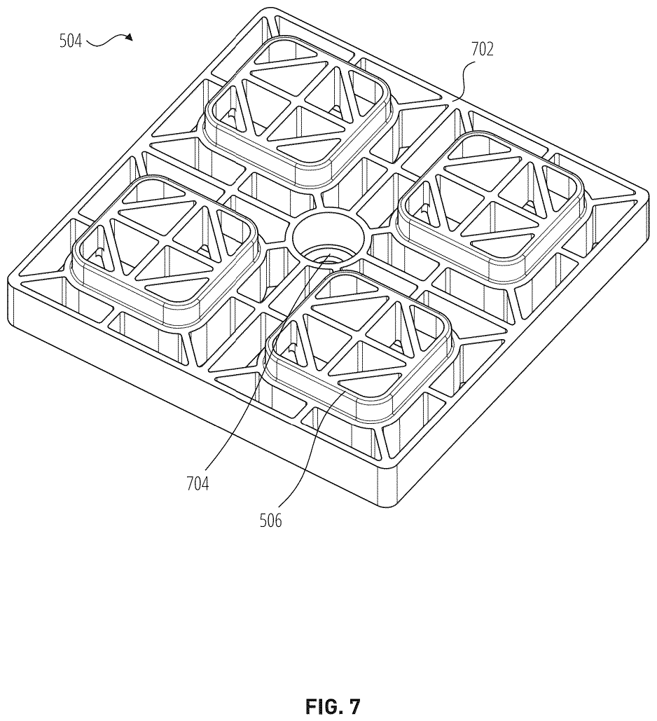

The first leveling ramp 102 may be used in combination with various features to achieve RV stability. By combining the first leveling ramp 102 with, for example, a leveling block 504, the first leveling ramp 102 may be disposed at a higher elevation in relation to the ground surface than if the first leveling ramp 102 were to be directly placed on the ground surface. In such embodiments, the first leveling ramp 102 may be secured to the leveling block 504 by aligning locking protrusions 506 with the locking features on the bottom surface of the first leveling ramp 102. The first leveling ramp 102 may then be pressed onto the leveling block 504 to secure and prevent the first leveling ramp 102 from moving laterally. As discussed in relation to FIG. 7, the locking protrusions 506 may extend away from a leveling block platform in a uniform or designated pattern that is complementary to the pattern in which the locking features are integrated into the bottom surface of the first leveling ramp 102.

Once a user has secured the first leveling ramp 102 to the leveling block 504, the user may drive their RV onto the combination first leveling ramp 102/leveling block. They may continue driving their RV onto the ramp until the tire 502 contacts the bump stop 206 extending in parallel along the rear end 508 of the first leveling ramp 102. Once the tire 502 touches the bump stop 206, the driver of the RV will feel, via tactile feedback, the tire 502 being in the correct position on the top surface of the first leveling ramp 102 and cease positioning operations of the RV.

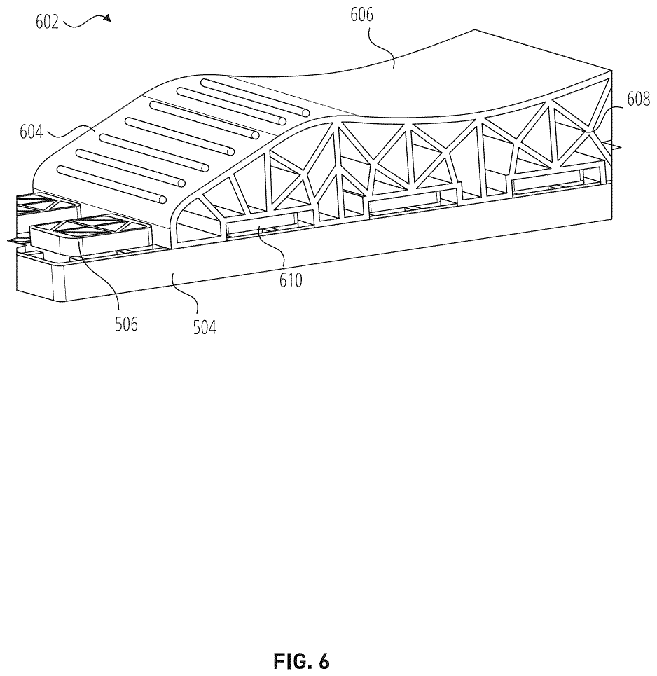

FIG. 6 is a diagram showing a perspective illustration of an example ultralight (UL) ramp disposed on a leveling block, in accordance with various embodiments of the disclosed technology. The UL ramp 602 may comprise a leveling block 504, a locking protrusion 506, an UL ramp 602, an UL front end 604, an UL top surface 606, a skeleton side surface 608, and an UL locking feature 610.

The UL ramp 602 may be an alternative embodiment to the previously discussed leveling ramps. The UL ramp may be constructed from similar or different materials than the previously discussed leveling ramps. In some embodiments, the UL ramp 602, may, quantitatively, be constructed from less material or lighter material than the leveling ramps.

The UL ramp 602 may embody some, all, or none of the previously discussed features of the leveling ramps. For example, the UL ramp may include a UL front end 604 that is angled to allow for an RV to drive onto the UL ramp 602 in similar manner to operations discussed with relation to the leveling ramps. Further, the UL ramp 602 may include a UL top surface 606, which may or may not include a through-hole. The UL top surface 606 may similarly be concave or curved to accommodate a portion of the circumference of a tire. The UL top surface 606 may include a bump stop or may merely be curved with sufficient flection to provide tactile feedback to the RV operator based on the tire reaching a maximum curvature of the top surface (e.g., the UL top surfaces 606 may be curved enough to prevent a tire for over rotating past the end of the UL top surface 606). The UL ramp 602 may be internally constructed with a skeleton side surface 608. The skeleton construction may extend through the interior of the UL ramp. The construction may include various angles and geometries of structured material to support the UL ramp 602 when it is loaded with an RV, while maintaining a slimmer, lighter weight design than its leveling ramp counterpart. The UL ramp 602 may further include a UL locking feature 610 which may be a depression integrated into the skeleton side surface 608 that either extend from a first skeleton side surface 608 to a second skeleton side surfaces (not shown), such that the UL ramp 602 can be laterally slid onto the leveling block 504 or, alternatively, may include distinct depressions into the bottom of the UL ramp 602, such that the UL ramp 602 can be placed onto the leveling block 504 by aligning the depressions with the locking protrusions 506 in a manner similar to that embodied by the leveling ramp.

FIG. 7 is a diagram showing a perspective illustration of an example leveling block, in accordance with various embodiments of the disclosure technology. The leveling block 504 may comprise one or more locking protrusions 506, a leveling block platform 702, and a leveling block through-hole 704. Embodiments of the leveling block 504 may include various numbers of locking protrusions 506. For example, the locking protrusions 506 may be disposed on the leveling block platform 702 in a grid format, as shown, or may be disposed in a non-grid format, such as by alternating position from left to right. Further, FIG. 7 depicts the locking protrusions 506 in a 2×2 format, such that the locking protrusions 506 are disposed on the leveling block platform 702 two locking protrusions 506 wide by two locking protrusions 506 long. Other dimensions of locking protrusions 506 disposed on the leveling block platform 702 may exist. For example, a leveling block 504 may be 1-25 locking protrusion 506 wide and 1-25 locking protrusion 506 long. For example, FIGS. 5-6 depict a leveling block in a 2×4 format.

The leveling block 504 may be structured on a leveling block platform 702, which may be sized in accordance with the number of locking protrusions 506 disposed thereon. The leveling block 504 may also include a leveling block through-hole 704, which may allow the leveling block 504 to be carried using the previously discussed lock and carry system in combination with various leveling ramps. The leveling block through-hole 704 may be similar to through-hole 106 and may include a diameter and depth to permit the shaft of the lock and carry system to pass through the leveling block through-hole 704 to secure the lock and carry system for transport.

The locking protrusions 506 may be square with sharp corner or approximately square with rounded corners, as depicted. Other shapes of locking protrusions may exist. Furthermore, leveling blocks may be stacked on top of one another to increase the height of the leveling blocks and subsequently the leveling ramps disposed thereon.

The combination of leveling ramps, leveling blocks, and lock and carry systems may assist RV enthusiasts in safely and comfortably operating an RV, especially when positioning the RV for short-or long-term parking. By providing a leveling ramp that can easily be retrieved, positioned, driven-onto, transported, and stored, the present disclosure improves the overall quality of experience RV enthusiasts may have in the field.

Another example of a leveling block set is disclosed in U.S. Pat. No. 10,053,344, granted Aug. 21, 2018, entitled LEVELING SYSTEM INCLUDING STORAGE AND TRANSPORT HANDLE assigned to Camco Manufacturing, Inc., the assignee of the subject application, the entire disclosure of which is hereby incorporated by reference.

Another example of a leveling block set is disclosed in U.S. patent application Ser. No. 18/446,991, filed Aug. 9, 2023, entitled LEVELING BLOCK SET assigned to Camco Manufacturing, Inc., the assignee of the subject application, the entire disclosure of which is hereby incorporated by reference.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

The terms “approximately” and “substantially” are used to account for variations that may occur due to manufacturing tolerances, measurement inaccuracies, and other practical considerations in implementing the described technology. The term “approximately” refers to a value or range that is close to the stated value but allows for minor deviations, typically within ±10%, unless otherwise specified, that do not materially affect the function or purpose of the invention. Similarly, the term “substantially” is used to indicate that a particular feature, characteristic, or result is largely present or achieved, with allowable variations without deviating from the intended scope and function of the invention. These terms should be interpreted in a manner consistent with the understanding of a person skilled in the art.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A leveling ramp, comprising:
a frame comprising a bottom surface, a top surface, a rear end, a front end, and side surfaces;
the top surface being curved to accommodate a tire;
the front end being angled to facilitate driving onto the leveling ramp;
the bottom surface comprising a plurality of locking features, wherein the locking features comprise cutouts integrated into the frame;
the bottom surface comprising a notch, the notch integrated into at least one of the locking features;
a bump stop disposed on the top surface adjacent to and extending from the rear end,
wherein the bump stop and the notch define a complementary transport pattern; and
a through-hole disposed through the center of the top surface.

2. The leveling ramp of claim 1, further comprising a mound disposed between the top surface and the front end that extends away from the top surface and a complementary valley on the bottom surface such that, when a second leveling ramp is stacked on a first leveling ramp, the mound rests in the complementary valley.

3. The leveling ramp of claim 1, further comprising a lock and carry system, the lock and carry system, comprising:
a grip and a shaft, the grip positioned at a first end and the shaft releasably attached to the grip and terminating at a second end, the first end and the second end in opposing relation to one another, the second end defining a first engagement member; and
a receiver comprising a base, a shank, the shank extending from the base and terminating at a lip, and a second engagement member,
wherein the shank defines a passageway that is configured to receive at least a portion of the first engagement member, and wherein the first engagement member secured to the second engagement member.

4. The leveling ramp of claim 1, wherein at least one of the plurality of locking features is square-shaped.

5. The leveling ramp of claim 1, wherein the bump stop is configured to provide tactile feedback to a driver when a vehicle is positioned correctly on the leveling ramp.

6. The leveling ramp of claim 3, wherein the through-hole is configured to receive the lock and carry system.

7. A recreational vehicle ramp for stabilizing or lifting a recreational vehicle off a ground surface, comprising:
a molded-plastic frame comprising a bottom surface with depressed locking features, a curved top surface, a rear end, and angled front end, and two side surfaces;
the curved top surface being concave to accommodate a recreational vehicle tire;
the angled front end being rectilinear to the bottom surface and configured to facilitate driving onto the recreational vehicle ramp;
the bottom surface comprising two or more depressed locking features and a notch, wherein the locking features comprise square-shaped cutouts integrated into the molded-plastic frame and wherein the notch is further integrated into the square-shaped cutouts;
a handle integrated into both side surfaces of the molded-plastic frame; and
a leveling block comprising square locking protrusions disposed on a leveling block platform.

8. The recreational vehicle ramp of claim 7, wherein the square locking protrusions of the leveling block correspond to the depressed locking features of the bottom surface, such that when the recreational vehicle ramp is disposed on the leveling block, the recreational vehicle ramp is secured to the leveling block by the square locking protrusions securing within the depressed locking features.

9. The recreational vehicle ramp of claim 7, further comprising a lock and carry system, the lock and carry system, comprising:
a grip and a shaft, the grip positioned at a first end and the shaft releasably attached to the grip and terminating at a second end, the first end and the second end in opposing relation to one another, the second end defining a first engagement member; and
a receiver comprising a base, a shank, the shank extending from the base and terminating at a lip, and a second engagement member,
wherein the shank defines a passageway that is configured to receive at least a portion of the first engagement member, and wherein the first engagement member secured to the second engagement member.

10. The recreational vehicle ramp of claim 9, further comprising a through-hole disposed in the center of the curved top surface configured to secure the lock and carry system therein.

11. The recreational vehicle ramp of claim 7, wherein the two or more depressed locking features comprises six depressed locking features.

12. The recreational vehicle ramp of claim 7, further comprising a bump stop configured to provide tactile feedback to a driver when the recreational vehicle is positioned correctly on the recreational vehicle ramp.

13. The recreational vehicle ramp of claim 7, wherein the angled front end further comprises a first angled end affixed to the bottom surface and a second angled end affixed to the curved top surface, wherein a surface between the first and second angled ends is substantially flat.

14. A leveling ramp system, comprising:
a first leveling ramp, a second leveling ramp, and a lock and carry system;
each of the first and second leveling ramps, comprising a bottom surface, a top surface, a rear end, a front end, and side surfaces;
each top surface being curved to accommodate a tire;
each front end being angled to facilitate driving onto the leveling ramp;
each bottom surface comprising a plurality of locking features, wherein the locking features comprise square-shaped cutouts integrated into the bottom surface;
a bump stop disposed at a junction of the rear end and top surface, extending away from the top surface in line with the rear end;
a handle integrated into at least one of the side surfaces of each leveling ramp; and
a through-hole disposed in the center of each top surface;
wherein the first leveling ramp is configured to be stacked on the second leveling ramp and secured together via the lock and carry system.

15. The leveling ramp system of claim 14, wherein the lock and carry system further comprises:
a grip and a shaft, the grip positioned at a first end and the shaft releasably attached to the grip and terminating at a second end, the first end and the second end in opposing relation to one another, the second end defining a first engagement member; and
a receiver comprising a base, a shank, the shank extending from the base and terminating at a lip, and a second engagement member,
wherein the shank defines a passageway that is configured to receive at least a portion of the first engagement member, and wherein the first engagement member secured to the second engagement member.

16. The leveling ramp system of claim 14, further comprising a leveling block comprising square locking protrusions disposed on a leveling block platform.

17. The leveling ramp system of claim 14, wherein each leveling ramp comprises six locking features.

18. The leveling ramp system of claim 14, wherein the first leveling ramp is stacked on top of the second leveling ramp and the bump stop of the second leveling ramp secured within a notch of the first leveling ramp.

19. The leveling ramp system of claim 18, wherein the notch is integrated into at least two of the locking features integrated into the bottom surface of each leveling ramp.

20. The leveling ramp system of claim 14, further comprising a third leveling ramp stackable with the first and second leveling ramps and securable with the lock and carry system.
